(19) United States
(12) Patent Application Publication
(10) Pub. No.: US 2011/0181518 A1
(43) Pub. Date: Jul. 28, 2011

(54) NETBOOK WITH A DISPLAY SCREEN ON TOP FACE FOR DELIVERING MEDIA ASSETS

(76) Inventor: Yang Pan, Singapore (SG)

(21) Appl. No.: 12/692,611

(22) Filed: Jan. 24, 2010

(51) Int. Cl. G06F 3/041; G06F 3/048

(52) U.S. Cl. 345/173; 715/853; 715/764

(57) ABSTRACT

A portable computing device is disclosed. The device may be based upon a netbook according to the preferred embodiment. The device comprises an additional display screen on the top face of the device. The device is used as a media player in a folded form and as a general purpose computing device in an unfolded form. The device operated as a media player is in a low power operation mode. The additional display screen is used as the display for the media player.

### CROSS-REFERENCE TO RELATED APPLICATIONS

Not applicable.

### BACKGROUND

1. Field of Invention

This invention relates generally to a portable computing device. More specifically, the invention describes a portable computing device such as a netbook with an additional display screen on top face for delivering media assets.

2. Description of Prior Art

Netbooks are a branch of subnotebooks, a rapidly evolving category of small, light and inexpensive laptop computers suited for general computing and accessing web-based applications. With primary focus given to web browsing and e-mailing, netbooks rely heavily on the Internet for remote access to web-based applications and are targeted increasingly at cloud computing users who rely on severs and require a less powerful client computer.

Because they are very portable, netbooks are rapidly gaining popularity among Internet users. The netbooks may also be used by a user to select and to play a media assets. The media asset may be delivered to the user by employing a media player program in the device. However, the user may be more accustomed to select and to play the media asset using a portable media player such as for example, an iPod from Apple Inc. of Cupertino, Calif. The portable media player as a dedicated media delivery system provides a more user friendly interface.

In order to achieve portability, many portable media players use minimalist displays that allow the user access to the media assets via simple graphical user interfaces. The large number of media assets are organized in a way of automatic hierarchical categorization by metadata as disclosed in a U.S. Pat. No. 6,928,433 to Goodman and Egan (2005). Robbin et al further disclosed a hierarchically ordered graphical user interface in US patent application 2004/0055446. A user, guided progressively by a user interface from the higher order to the lower order, can select a desired media asset.

Therefore, it is desirable to have a netbook providing a means of delivering a media asset to a user in a similar manner as in a portable media player.

### SUMMARY OF THE INVENTION

It is an objective of the present invention to provide an improved portable computing device which delivers media assets to a user in a similar manner as in a dedicated portable media player, while the portable device can also be used as a general computing device.

Netbooks are used exemplarily in the present disclosure without limiting the scope of the inventive concept.

According to a preferred embodiment of the present invention, the improved netbook comprises an additional display screen on the top face of the device. The added display screen might be utilized in a similar manner as a display screen of the portable media player. According to one implementation, the display is of a touch-screen type. A user may use his or her finger or a stylus to select a desired media asset in a progressive manner from a hierarchical user interface.

The improved netbook further comprises a switch to switch on the device as a media player when the device is in a folded form. The media player may be a separate device integrated with the netbook according to one implementation. The media player may also be a program of the netbook according to another implementation. The media player and the netbook may share a number of components. The device provides a means of consuming much less power when it is operated as a media player. The improved netbook is operated as a general purpose computing device when it is in an unfolded form. When the netbook is unfolded, the display screen on the top face is switched off.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram illustrating an exemplary netbook with an added display screen on the top face of the device;

FIG. 2 is a schematic diagram illustrating two implementations of the display screen on the top face of the device.

FIG. 3 is a schematic diagram illustrating two different implementations of the improved netbook design;

FIG. 4 is a schematic diagram illustrating functional blocks of an exemplary implementation of the device;

FIG. 5 is a flowchart illustrating the operation of the netbook as a dedicated media player;

FIG. 6 is a flowchart illustrating a process that the netbook is switched from a dedicated media player to a conventional netbook.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

The present disclosure uses a netbook as an exemplary case to illustrate the inventive concept. The inventive concept can be applied to any other general purpose portable computing device. Netbooks are a branch of subnotebooks, a rapidly evolving category of small, light ad inexpensive laptop computers suited for general computing and accessing web-based applications.

The media assets may include an audio file such as a music clip, a video file, a text file such as an e-book, a multimedia file and a movie. The media assets may be stored in a storage unit of the netbook. The media assets may also be delivered from a server in the Internet to the netbook.

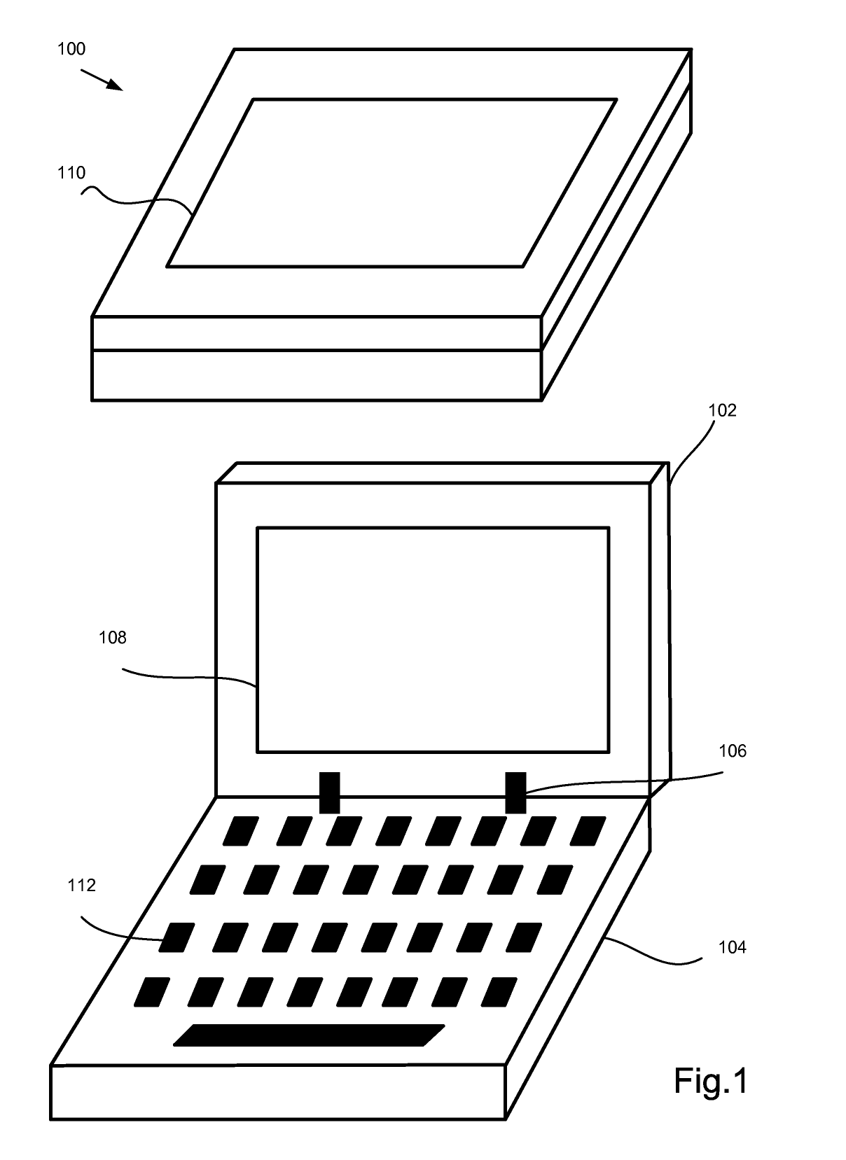

FIG. 1 is a schematic diagram illustrating an exemplary netbook 100. The netbook 100 comprises a display part 102, a housing part104 and a hinge part106. The display part 102 further comprises a conventional display screen 108 for the netbook and an additional display screen 110 on the top face of the netbook 100. According to a preferred embodiment of the present invention, the display screen 108 is a LCD (Liquid-Crystal-Display) and the display screen 110 is a touch-screen type of display. The housing part 104 comprises a keyboard 112. The housing part may further comprise a pointing device such as a touchpad. The electronic components of the netbook are mostly contained in the housing part104. The hinge part 106 provides a mechanism for the netbook to be folded or unfolded.

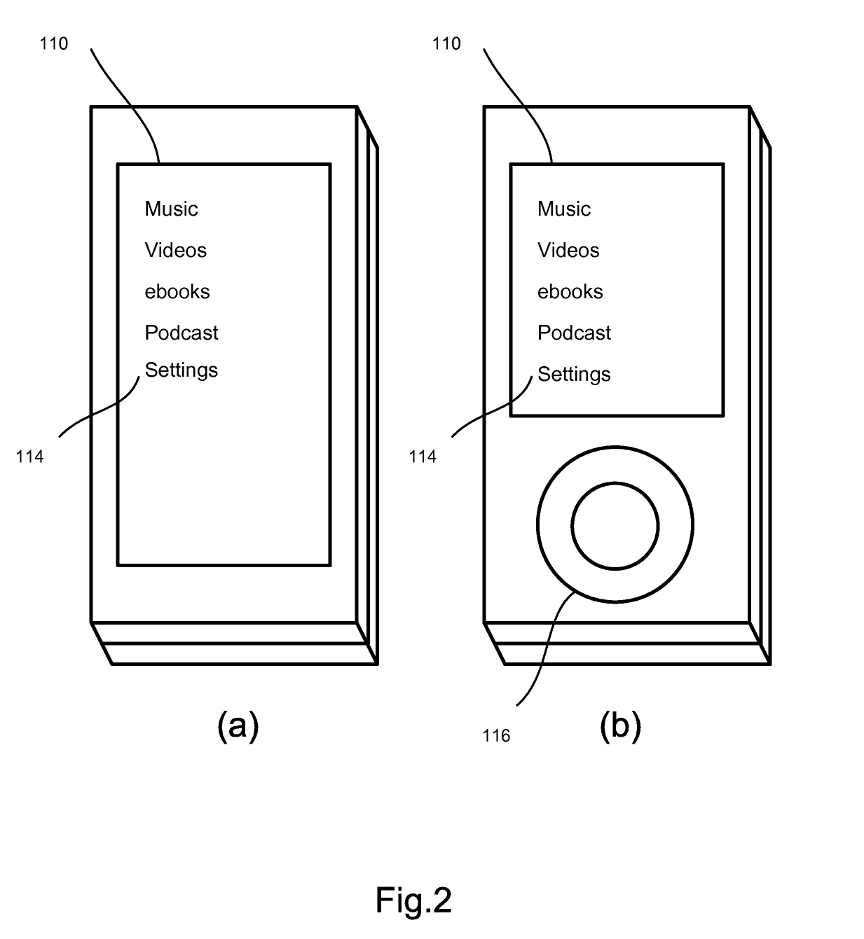

FIG. 2 is a schematic diagram illustrating two implementations of the display screen on the top face of the device. FIG. 2(a) shows that the display screen is a touch-screen type of display. A hierarchical user interface 114 is displayed and the user may use a finger or a stylus to make a selection of a desired item. FIG. 2(b) shows that the display screen is a LCD type of display. A user input device 116 is employed to operate the media player. The user input device may be a rotational user input device as used in an iPod device from Apple Inc. A user is typically more accustomed to the hierarchical user interface for media assets selection. After the user selects a specific media item from a specific hierarchical level, the next level of user selectable items will be displayed. The process is repeated until a desired media asset is finally selected by the user.

The netbook 100 with the additional display screen 110 can also be used as an e-book. The display 110 may be an e-paper as manufactured by E Ink Corporation, Cambridge, Mass. The netbook 100 may also be used as a video player.

According to another implementation, the display screen on the top of the device may further be employed for displaying an image when the device is not in use as a media player or as a general purpose computing device. When an e-paper is used as the display, there is no additional power consumption if the displayed image is not changed.

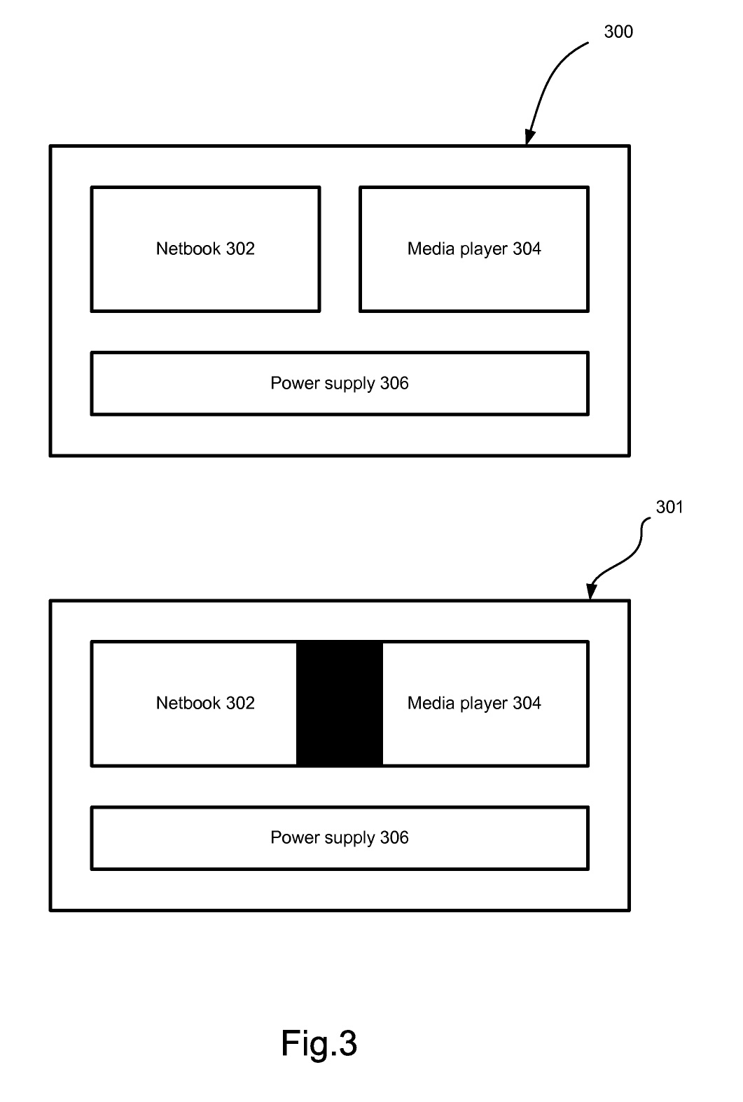

FIG. 3 is a schematic diagram illustrating two different implementations of the improved netbook design. As illustrated in 300, the netbook 302 and the media player 304 may be two different devices in one package sharing the same power supply 306. As shown in 301, the netbook 302 and the media player 304 may also share some components in additional to sharing the power supply 306. The shared components may include storage unit and some signal processing units.

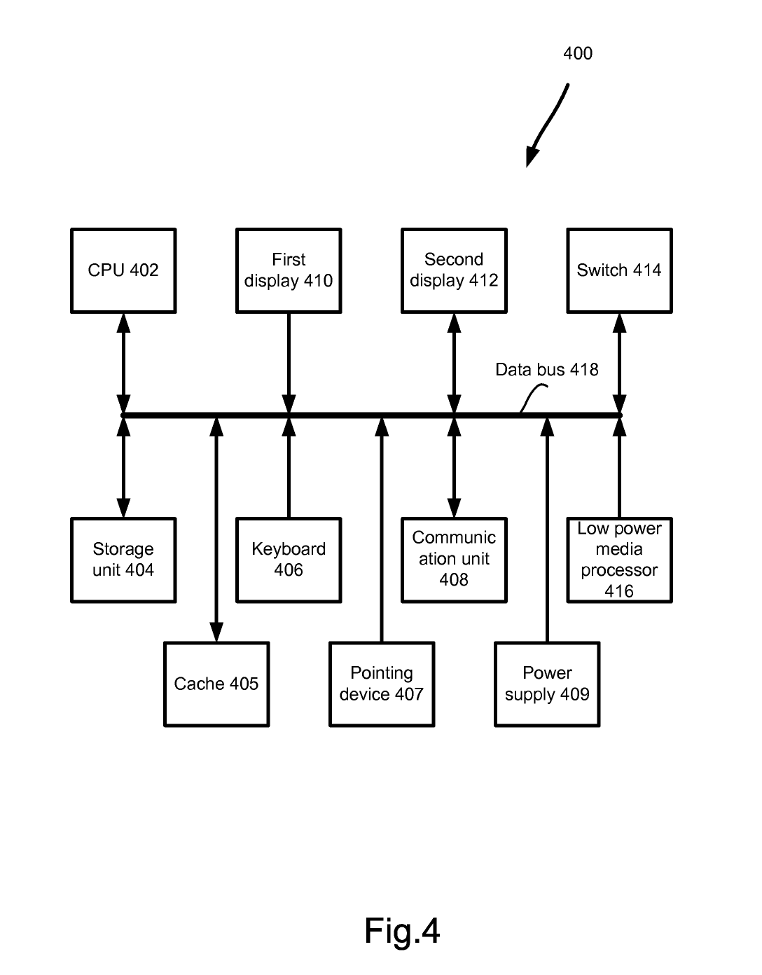

FIG. 4 is a schematic diagram illustrating functional blocks of an exemplary implementation of the device. The exemplary netbook 400 comprises a CPU (Central Processing Unit) 402 for controlling operations of the device. The netbook 400 further comprises a storage unit 404 and a cache 405. The storage unit 404 may be one or a plurality of flash memory devices. The storage unit 404 may also be a magnetic storage device. The cache 405 may be a Static Random Access Memory (SRAM) providing a much shorter access time to the memory. The netbook 400 also includes input devices such as a keyboard 406 and a pointing device 407. A pointing device may be a mouse or a touch-pad. A communication unit 408 is used to connect the netbook 400 to a communication network such as the Internet. The power supply 409 provides power for the operations of the device 400. The power supply 409 may be a rechargeable battery in an exemplary case.

The netbook 400 includes two display screens. The display screen 410 is conventional to a netbook. 410 may be a LCD type of display. The netbook 400 further comprises an added display screen 412 on the top face of the device. The display screen 412 is a touch-screen type of display according to the preferred embodiment of the present invention. The display screen may also be a LCD type display. If the LCD type of display is used for the media player, an input device such as for example, a rotational user interface is required to support the operation of the media player. A switch 414 is used to provide a switching means for device to be operated as a media player when the netbook 400 is in the folded form. When the netbook 400 is unfolded, the switch 414 switches off the media player and switches on the device as a general purpose computing device. The low power media processor 416 may comprise a processor, a DSP (Digital Signal Processor) and a CODEC (Coding and Decoding). The device 400 operated as a media player may consume significantly less power by design. The data bus 418 provides a means for the high speed data transfer.

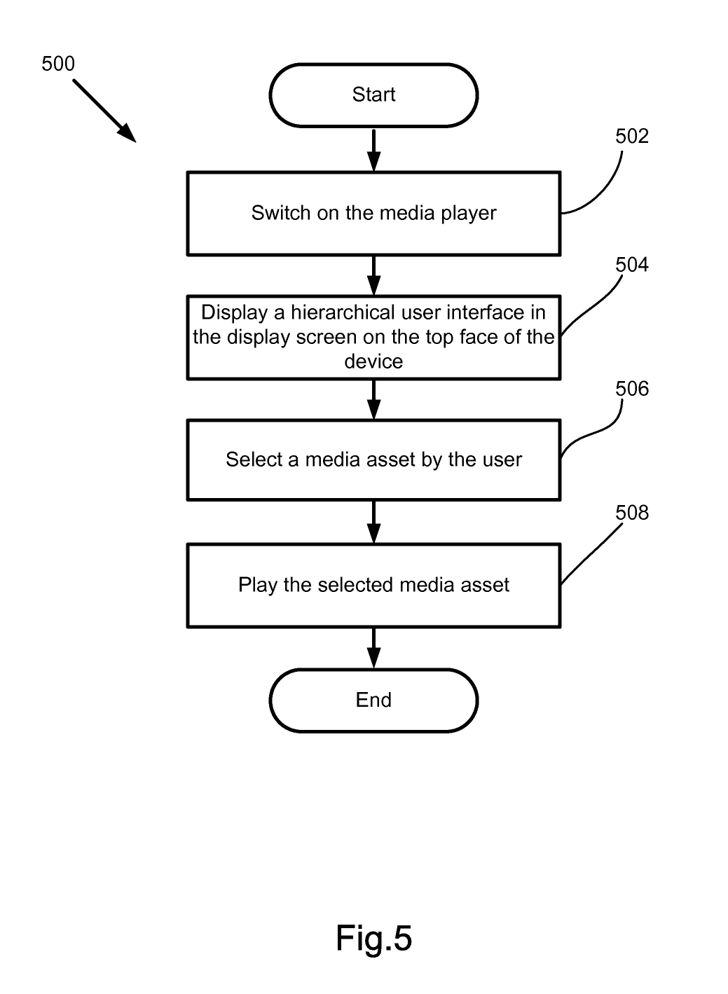

FIG. 5 is a flowchart illustrating the operation of the netbook as a dedicated media player. Process 500 starts with step 502 that the netbook in the folded form is switched on as a dedicated media player. In step 504, a hierarchical user interface as typically used in a portable media player such as an iPod is displayed on the display screen on the top face of the netbook. A desired media asset is selected by the user in step 506 by the use of the hierarchical interface. The selected media asset is played in step 508. The media asset may be an audio file, a video file, a text file, a multimedia file or a movie. The media assets may be stored in the storage unit of the netbook. The media asset may also be stored in a computing device connected to the netbook through a communication network such as the Internet. The media asset may be delivered to the netbook through the Internet. The media asset may also be delivered to the user through an ad hoc communication network.

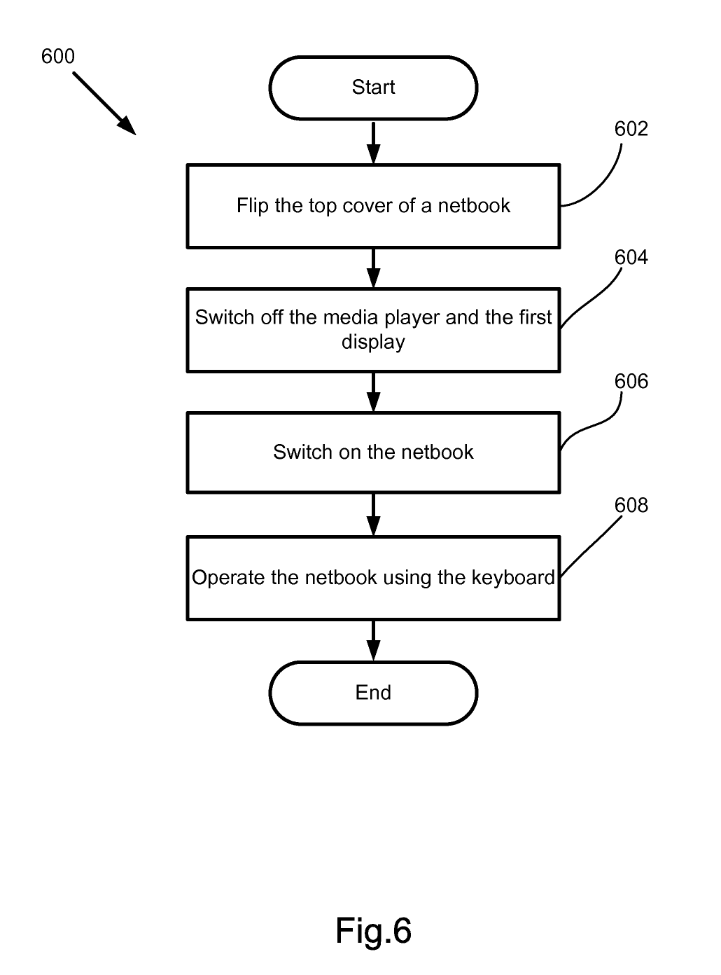

FIG. 6 is a flowchart illustrating a process that the netbook is switched from a dedicated media player to a conventional netbook. Process 600 starts with step 602 that the display part of the netbook is flipped. The media player is switched off in step 604 as the device is being unfolded. The netbook is switched on in step 606 and the device is operated in a conventional manner through a keyboard or a pointing device in step 608.

The improved netbook with an additional display screen can be used conveniently as dedicated media player or as a conventional netbook.

While the invention has been disclosed with respect to a limited number of embodiments, numerous modifications and variations will be appreciated by those skilled in the art. It is intended that all such variations and modifications fall with in the scope of the following claims:

1. A portable computing device in a flip form factor, the device comprising:
a. a display part having a first display screen on top planar face of the device and a second display screen on an opposite planar surface to said top planar face;
b. a housing part comprising one or more input devices; and
c. a hinge part for connecting the display part and the housing part,
wherein said first display screen comprising a delivering means of a hierarchical user interface of a media player when the device is in a folded form.

2. The device as recited in claim 1, wherein said input devices further comprising a keyboard and/or a pointing device.

3. The device as recited in claim 1, wherein said device further comprising:
a. a Central Processing Unit for controlling operations of the device;
b. one or a plurality of storage units for storing data files including media assets;
c. a media processor for delivering media assets by using said first display screen as a display means;
d. a communication unit for connecting said device to a communication network; and
e. a power supply for providing required power for the operations of the device.

4. The device as recited in claim 3, wherein said media processor comprising a low power operating mode of said Central Processing Unit.

5. The device as recited in claim 1, wherein said device further comprising a switch for switching operation modes of said device in between a media player when the device is in a folded form and a general purpose computing device when the device is in a unfolded form.

6. The device as recited in claim 1, wherein said first display screen further comprising a touch-screen type of display.

7. The device as recited in claim 1, wherein said first display screen further comprising an e-paper type of display.

8. The device as recited in claim 1, wherein said portable computing device comprising a netbook.

9. The device as recited in claim 1, wherein said media player delivering a media asset from the following group comprising:
a. an audio file;
b. a video file;
c. a text file;
d. a multi-media file; and
e. a movie.

10. A portable computing device in a flip form factor comprising two following modes of operations in an exclusive manner:
a. a media player when said device is in a folded form; and
b. a general purpose computing device when said device is in a unfolded form.

11. The device as recited in claim 10, wherein said device comprising a display part, a housing part and a hinge part.

12. The device as recited in claim 11, wherein said display part comprising a first display screen on top planar face of the device and a second display screen on an opposite planar surface to said top planar face.

13. The device as recited in claim 12, wherein said first display screen comprising a means of displaying a hierarchical user interface for media assets.

14. The device as recited in claim 12, wherein said first display screen comprising a touch-screen type of display.

15. The device as recited in claim 12, wherein said first display screen comprising an e-paper type of display.

16. The device as recited in claim 10, wherein said portable computing device comprising a netbook.

17. The device as recited in claim 10, wherein said media player comprising an e-book.

18. A method of delivering a media asset to a user through the use of a portable computing device comprising a display part and a housing part in a flip form factor, the method comprising:
a. switching on the device as a media player by actuating a switch when the device is in a folded form;
b. displaying a hierarchical user interface in a first display screen on top face of the device;
c. selecting a media asset;
d. playing the selected media asset; and
e. switching off the media player and switching on the device as a general purpose computing device using a second display screen, when the device is in a unfolded form.

19. The method as recited in claim 18, wherein said method further comprising a step of setting the computing device in a mode of low power operation after “switching on” the device as the media player.

20. The method as recited in claim 18, wherein said method further comprising a step of displaying an image on said first display screen when the device is idling.
